(19) United States
(12) Patent Application Publication
(10) Pub. No.: US 2017/0077597 A1
(43) Pub. Date: Mar. 16, 2017

(54) NFC ANTENNA APPARATUS AND MOBILE TERMINAL

(71) Applicant: Huizhou Speed Wireless Technology Co., Ltd., Huizhou (CN)

(72) Inventors: Sile Gong, Huizhou (CN); Yanmei Shi, Huizhou (CN); Bin Yu, Huizhou (CN)

(21) Appl. No.: 14/974,554

(22) Filed: Dec. 18, 2015

(30) Foreign Application Priority Data
Sep. 15, 2015 (CN) 201510584447.2

(51) Int. Cl. H01Q 1/42; H01Q 1/24; H01Q 7/00; H04W 4/00; H04M 1/02

(52) U.S. Cl. CPC H01Q 1/42; H04W 4/008; H04M 1/0202; H01Q 7/00; H01Q 1/243

(57) ABSTRACT

The present invention discloses an NFC antenna apparatus, which includes a metal cover, and an antenna module having a conductive coil. The metal cover is equipped with at least two openings and at least one slot. The slot is used to connect with different openings. The conductive coil intersects with at least one slot. The present invention also discloses a mobile terminal. This invention can reduce the degree of damage to the metal cover through changing slotting method of NFC antenna, increase the strength of the structure of the NFC antenna apparatus, and thus enhance the strength of the structure of the mobile terminal.

### CROSS REFERENCE TO RELATED APPLICATIONS

The present application claims priority from Chinese Patent Application No. 201510584447.2, filed Sep. 15, 2015, which is hereby incorporated herein by reference.

### TECHNICAL FIELD

The present invention relates to the near field communication field, and especially relates to an NFC antenna apparatus and a mobile terminal.

### BACKGROUND

Antenna is a kind of device using the frequency characteristics to receive and transmit signals. Recent years, with the development of wireless terminals and communication technologies, near-field communication (NFC) technology gets a growing number of research and application. The NFC technology began with the RFID tags (Radio Frequency Identification) technology, which is combining induction card reader and induction card on a single chip to realize point-to-point data exchange. NFC chips are installed in the mobile terminals such as mobile phones for realizing functions of small electronic payment, intelligent recognition and data transmission. Through the use of NFC technology, devices such as cell phone, PDA, computers can easily realize wireless connection and data sharing.

Among the existing technologies, the solution of a communication company usually has a slit from camera opening of the mobile terminal to the edge of metal cover. By destroying the restraint of the metal cover to the NFC antenna, the NFC antenna can effectively couple the metal cover, and then use the metal to excite magnetic field to realize the NFC function. However, in this design, the coupling current on the metal cover can only distribute around the camera opening and gap, the area of current distribution is small, and will restrict the overall performance of the NFC directly.

### SUMMARY OF THE INVENTION

The main purpose of the present invention is to provide an NFC antenna apparatus and a mobile terminal, aiming at improving structural strength of NFC antenna apparatus, and thus enhancing the complete machine's structural strength of the mobile terminal.

In order to achieve the above purpose, the present invention provides an NFC antenna apparatus including a metal cover and an antenna module, and the antenna module consists of conductive coil. Its characteristic is that the metal cover is equipped with at least two openings and at least one slot. The slot is used to connect different openings, and the conductive coil intersects with at least one slot.

Preferably, the slot and the openings connected with the slot are horizontally disposed or vertically disposed.

Preferably, the intersection is perpendicular intersection.

Preferably, the width of the slot is not less than 0.5 mm.

Preferably, the openings include a camera reserved opening, a fingerprint identification reserved opening and a flashlight reserved opening.

Preferably, the antenna module includes a substrate and a near field communication module, the conductive coil is located on the substrate, and the near field communication module is connected with the conductive coil electrically.

Preferably, the antenna module also includes a feeding point and a shielding plate. The feeding point is set at an end of the conductive coil, the shielding plate is set on one side of substrate which is deviated from the conductive coil, and the near field communication module is connected with the feeding point.

Preferably, the metal cover is divided into an upper, a middle and a lower sections. A plastic slit is defined between the upper and the middle sections, and the conductive coil is set on the middle section.

Preferably, the width of the plastic slit is above 1.5 mm.

In addition, in order to achieve the above purposes, the present invention also provides a mobile terminal which includes an NFC antenna apparatus as described above.

Through changing the slotting method of NFC antenna, the present invention effectively takes advantage of a camera opening and a fingerprint identification opening, or the aperture area of a camera opening and a flashlight opening, the coupling current can distribute not only around the two openings but also between the two aperture areas. The entire current distribution area is nearly twice larger than that of the solution of the existing company. In other words, the currents accumulated on the metal cover are nearly twice, and can enhance the overall performance of the NFC effectively.

### BRIEF DESCRIPTION OF THE DRAWINGS

FIG. 1 is the structural schematic diagram of an NFC antenna apparatus according to the first preferred embodiment of the present invention.

FIG. 2 is the sectional view of the NFC antenna apparatus taken along the line AA in FIG. 1.

FIG. 3 is the structural schematic diagram of an NFC coil of the NFC antenna apparatus of the present invention.

FIG. 4 is a schematic diagram showing the coupling current distribution and flowing trend of the NFC antenna apparatus in FIG. 1.

FIG. 5 is a schematic diagram showing the coupling current distribution and flowing trend of the NFC antenna apparatus of the second embodiment of the present invention.

FIG. 6 is the sectional view of the NFC antenna apparatus taken along the line BB in FIG. 5.

FIG. 7 is a schematic diagram showing the coupling current distribution and flowing trend of the NFC antenna apparatus of the third embodiment of the present invention.

FIG. 8 is the sectional view of the NFC antenna apparatus taken along the line CC in FIG. 7.

The description of drawings marks: 1 is the metal cover, 11 is the middle section, 12 is the upper section, 13 is the plastic slit, 14 is the camera reserved opening, 15 is the fingerprint identification reserved opening, 16 is the flashlight reserved opening, 17 is the slot, 21 is the conductive coil, 22 is feeding point, 23 is the substrate, 24 is the near field communication module, 25 is the feeding pin, 3 is the shielding plate.

The realization of the purpose, the function characteristics and the advantages of this invention will be further illustrated combined with the embodiments and the accompanying drawings.

### DETAILED DESCRIPTION OF THE INVENTION

It should be clear that the concrete preferred embodiments described here are only used to explain the present invention, but not used to limit the invention.

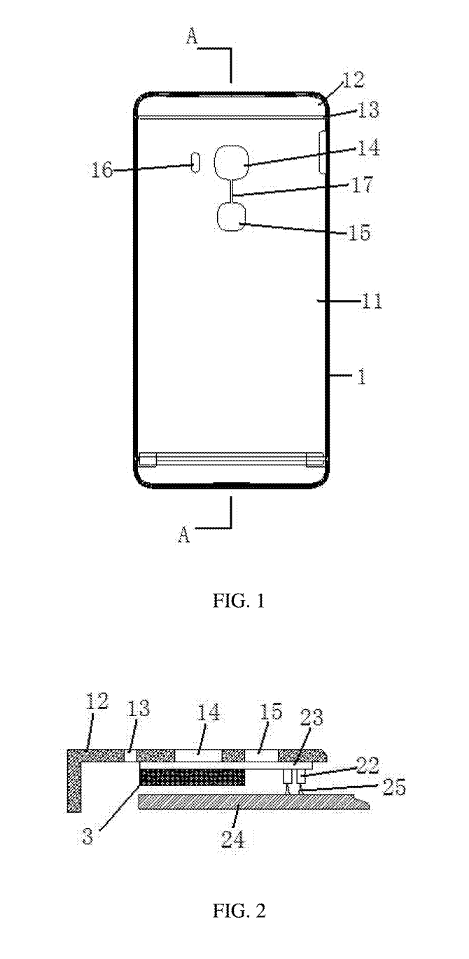

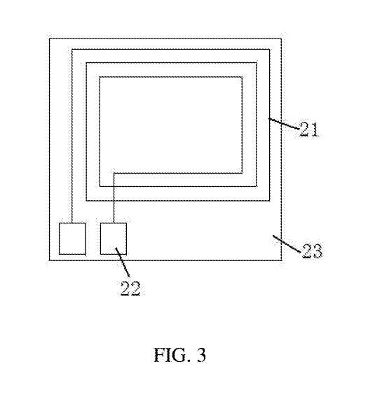

The present invention provides an NFC antenna apparatus, referring to FIG. 1 through FIG. 8, which includes a metal cover and an antenna module. The antenna module consists of a conductive coil. The metal cover is equipped with at least two openings and at least one slot. The slot is used to connect different openings, and the conductive coil intersects with at least one slot.

The intersection, viewed from the direction that perpendicular to the plane constituted by the conductive coil, is that the conductive coil and the slot have intersection point. Intersection slot is the slot which intersects with the conductive coil. The conductive coil intersects with at least one slot, and the implicit structure is that at least one opening which is connected with an intersection slot is disposed within the inner ring of the conductive coil, and the other opening which is connected with the intersection slot is disposed outside an outer ring of the conductive coil.

Through changing the slotting method of the NFC antenna, the NFC antenna apparatus of the present invention can reduce the degree of damage to the metal cover, and increase the strength of the structure of the NFC antenna apparatus, and thus enhance the complete machine's structural strength of mobile terminal. In addition, the coupling current of the NFC antenna apparatus can form a small closed loop along the area of the opening and the slot on the metal cover, which is different from that of the traditional NFC antenna. The traditional NFC antenna has coupling current flowing along the edge, the slotting and the opening area of the metal cover to form a big closed loop. In contrast, the magnetic field of the present invention is much stronger, and the communication distance is much farther.

The antenna module also includes a feeding point, a substrate, a shield plate, and a near field communication module. The feeding point is located at the end of the conductive coil. The conductive coil is set on one side of the substrate, and the shielding plate is set on the other side. The shielding plate can be ferrite, and attached on the substrate with adhesive to prevent magnetic field excited by the conductive coil from radiating into the inside of the terminal, and enhance the intensity of the magnetic field radiating outwardly. The conductive coil is attached to the inner surface of the metal cover closely through a double-sided adhesive or other craft. The conductive coil, the feeding point and the substrate compose an NFC coil. The NFC coil can be flexible circuit board or printed circuit board. The material of substrate can be PET (polyethylene terephthalate), PI (Polyimide) or FR4 (grade code of fire resistant material which is a resin material that can self-extinguish fire when it is in state of combustion). The conductive coil can have spiral winding form and copper material, and be formed in the substrate by printing or etching technique. The near field communication module is equipped with a feeding pin, and the NFC coil connects with the feeding pin of near field communication module by feeding point, to ensure that the signal of near field communication module can access to the conductive coil. When signals flow through the conductive coil, magnetic field is stimulated, and forms current on the surface of metal cover. Because of the position relationships that one side of the wire coil intersects with the slot, the strongest current is distributed on the edge of the slot, moreover, the inside surface of the openings also form a strong current distribution, which makes the area of opening and slot excite magnetic field and then realize near field communication function of the terminal.

In the preferred embodiment of the invention, the conductive coil is rectangular. The slot is cut by CNC machine, and the width of slot is not less than 0.5 mm. The intersection is vertical so that can excite stronger magnetic field. The slot is perpendicular to the openings which are connected with the slot (that is, when the opening is round, the slot passes the circle's center, while when the opening is rectangular, the slot is perpendicular to the side of the rectangle). The slot and the openings connect perpendicularly, which can make the current density on the inside surface of the openings much bigger, and the excited magnetic field much stronger. The openings include a camera reserved opening, a fingerprint identification reserved opening and a flashlight reserved opening. The camera reserved opening and the flashlight reserved opening are placed horizontally, and the camera reserved opening and the fingerprint identification reserved opening are placed vertically. The metal cover is divided into an upper, a middle and a lower sections which form three-section metal structure. The NFC coil is set on the middle section of the metal cover, and the upper and the lower section can be used to design communication antennas (such as diversity antenna, GPS and WiFi antenna). Plastic is used to insulate the upper from the middle section, and the middle from the lower section respectively, and the plastic gap between the upper and the middle sections is above 1.5 mm. In order to ensure not causing interference to the upper section and the middle section as the communication antennas, the conductive coil should not cross over the boundary between the plastic gap and the middle section.

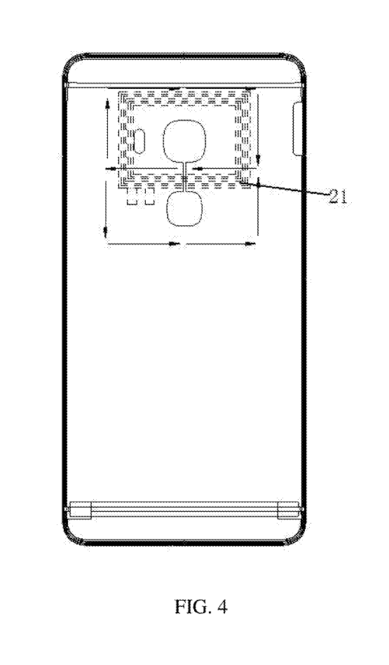

FIG. 1 through FIG. 4 are the structural schematic diagrams of the NFC antenna apparatus of the first preferred embodiment of the present invention. In the first preferred embodiment, referring to FIG. 1 through FIG. 4, the camera reserved opening and the fingerprint identification reserved opening are connected by slotting. The inner ring of the conductive coil covers the camera reserved opening and the flashlight reserved opening, and one side of the inner ring crosses the slot and forms orthogonal relationship with the slot. FIG. 4 is a schematic diagram showing the coupling current distribution and flowing trend of the NFC antenna apparatus of the first preferred embodiment. When signals flow through the conductive coil, magnetic field is generated on the surface of the metal cover and forms coupling current on a surface of the metal cover. Since one side of the wire coil is orthogonal with the slot, the strongest current is distributed on the edge of the slot, and a strong current distribution is formed on the inner surface of the camera reserved opening, enabling the camera reserved opening and slotting area to excite magnetic field and to realize the near field communication function of the terminal.

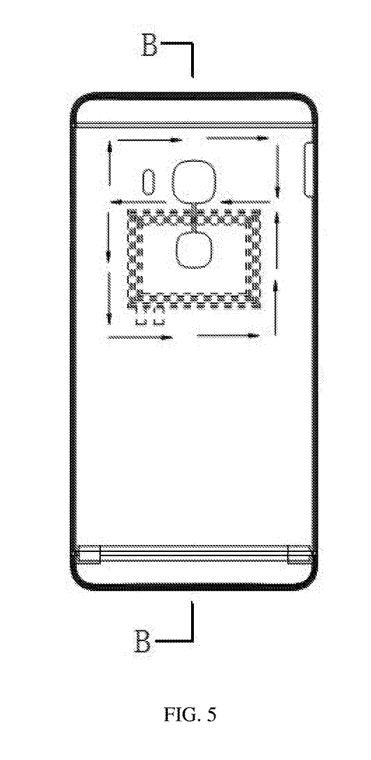

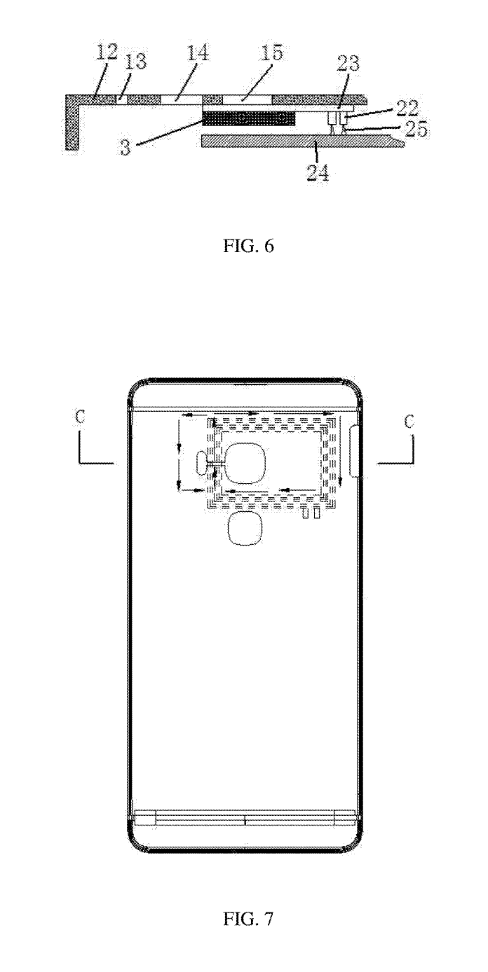

Referring to FIG. 5 and FIG. 6, compared with the first preferred embodiment, the location relationship between the conductive coil of the second preferred embodiment and the three openings has been changed. The inner ring of the conductive coil covers fingerprint identification reserved opening, and has one side across the slot to form orthogonal relation with the slot. Due to the change of the location relationship, the position of the coupling current distribution is changed accordingly, and the position of near field communication area is changed from the camera reserved opening to the fingerprint identification reserved opening.

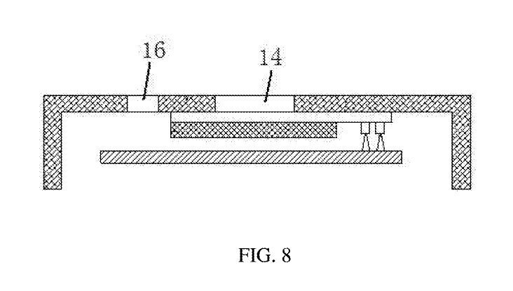

Referring to FIG. 7 and FIG. 8, the slot position of the third preferred embodiment is between the camera reserved opening and the flashlight reserved opening. Because the aperture diameter of the camera reserved opening is bigger than that of the flashlight reserved opening, the minimal size of the inner ring of the conductive coil covers the camera reserved opening. One side of the conductive coil crosses the slot and forms orthogonal relationship with the slot. The coupling current distribution area is mainly distributed on the camera reserved opening and the slot, as shown in FIG. 7.

The present invention also provides a mobile terminal, which includes the NFC antenna apparatus as described above.

Through changing the slotting method of NFC antenna, the mobile terminal of the invention reduces the degree of damage to the metal cover, increases the strength of the structure of the NFC antenna apparatus, and thus enhances the complete machine's structural strength of the mobile terminal.

The preferred embodiments of the present invention are shown above, and are not used to limit the scope of the invention patent. The descriptions and the appended drawings of the present invention can form the equivalent structure or equivalent process transformation, or be used in other related technical field directly or indirectly, all of which should be contained within the scope of the invention patent protection.

1. An antenna apparatus including a metal cover and an antenna module, the antenna module including a conductive coil, the metal cover having at least two openings and at least one slot, the at least one slot connecting with the at least two openings, the conductive coil intersecting the at least one slot, wherein the at least one slot and the at least two openings are surrounded by portions of the metal cover, and wherein the at least one slot does not extend to an edge of the metal cover.

2. The antenna apparatus according to claim 1, wherein the at least one slot and the at least two openings that connect with the at least one slot are horizontally disposed or vertically disposed.

3. The antenna apparatus according to claim 1, wherein the intersection is perpendicular intersection.

4. The antenna apparatus according to claim 1, wherein width of the at least one slot is not less than 1 mm.

5. The antenna apparatus according to claim 1, wherein the at least two openings include a camera reserved opening, a fingerprint identification reserved opening and a flashlight reserved opening.

6. The antenna apparatus according to claim 1, wherein the antenna module includes a substrate and a near field communication module, the conductive coil being located on the substrate, and the near field communication module being connected with the conductive coil electrically.

7. The antenna apparatus according to claim 6, wherein the antenna module also includes a feeding point and a shielding plate, the feeding point being set at an end of the conductive coil, the shielding plate being set on one side of substrate which is deviated from the conductive coil, and the near field communication module being connected with the feeding point.

8. The antenna apparatus according to claim 1, wherein the metal cover is divided into an upper, a middle and a lower sections, a plastic slit being defined between the upper and the middle sections, the conductive coil being set on the middle section.

9. The antenna apparatus according to claim 8, wherein width of the plastic slit is above 1.5 mm.

10. A mobile terminal comprising including the NFC antenna apparatus according to claim 1.
